(19) United States
(12) Patent Application Publication
(10) Pub. No.: US 2003/0212736 A1
(43) Pub. Date: Nov. 13, 2003

(54) System and method for activating and pausing a component

(76) Inventors: Sreekrishna Kotnur, Bangalore (IN); Sasank Kotnur, Bangalore (IN)

Correspondence Address: Welsh & Katz, Ltd., 22nd Floor, 120 South Riverside Plaza, Chicago, IL, 60606, US

(21) Appl. No.: 10/144,435

(22) Filed: May 10, 2002

(51) Int. Cl. G06F 15/16

(52) U.S. Cl. 709/202

(57) ABSTRACT

A system for activating and deactivating software components includes a server configured to select and manipulate a static agent, a server registry including static agent reference information and a static agent responsive to the server. The static agent is configured to generate a dynamic agent. The software component is responsive to the server by way of the static agent and a dynamic agent. The dynamic agent is responsive to the static agent and configured to manipulate the application registry. A registry reference repository stores details pertaining to the component and application registry. The application registry containing keys the component deployed in the system. The dynamic uses the key of the component to access the status field of the component and activating or deactivating the component.

### FIELD OF INVENTION

The present invention relates generally to a system and method for controlling software components and applications. More particularly the present invention relates to a system and method of using object oriented programming to activate, pause and control software components deployed in the system.

### BACKGROUND OF THE INVENTION

The ability to efficiently build high quality software in a very short period of time is a goal of many software firms, both large and small. Over the past decades, significant technological advancements have .addressed these issues, leading to new and simplified programming languages, improved database systems, and significant improvements in object oriented programming techniques. One such improvement has been the advent of component based programming techniques.

Component based programming involves writing or developing generally small components to perform specific tasks or functions, and integrating these components with other components, to form a larger component or application. Component based programming has led to the implementation of one of the object oriented techniques, namely, reusability. Building software from components involves creating an application, wholly or in part, from existing components.

The use of component technology is prevalent in the distributed computing environment. In this environment, different components perform different tasks, or functions. These components can be remotely disbursed over the network or system. Because the remoteness of the components, it can be difficult at times to maintain complete control over them.

Presently, there are no known mechanisms for controlling, activating or deactivating a software component on a remote system during runtime, without having to manually generate a code that accesses the resident application's program interface. The known solution for controlling remote software components requires human interaction, in which the user writes a computer code or programs the application program interface (API).

Several corporations, such as IBM Corporation's WEBLOGIC server and BEA System's WEBSPHERE server, provide a mechanism by which software components contained within them can be started or initialized at run time by the servers themselves. However, these mechanisms do not provide for control over distributed or remote software components.

Microsoft Corporation's provides certain API's in which a user can remotely stop processes in a system. However, the only way to achieve this function or task is for the user to manually code or send the instructions to the API. Neither IBM's nor BEA's servers provide a mechanism for pausing or resuming active or inactive software components using API's or automatically at run time, without requiring a user to manually generate a code. Additionally, there are no known middleware, application servers, or Object Request Broker System (ORBS) that can achieve automatic runtime activation or deactivation of a remote system.

One known mechanism for pausing and re-activating computations is by threading. Components can contain numerous threads in its program. A thread is a program that can be stopped or started by placing the thread into a state of wait or sleep. A single thread of a component can be put to sleep or wait, forcing the particular or specific computation of the thread to be paused for a duration, until the thread's state is reset back to active. To achieve this, the user must manually develop the program or code. Notably, the stopping and starting function is currently only applicable to threads, and not to an entire component.

A significant problem facing the distributed computing and software industry on the whole is developing a system or method to pause and re-activate components that are located remotely and involved in transactions and re-activating any such paused components. Another problem is figuring out how to initiate these components located on different platforms and operating systems, and developed in different languages.

Because there is the possibility that a component may malfunction or perform erratically, developing the ability to pause or re-activate a remote component without manual interaction or coding is vitally important. The value of such a system is even greater if there exists a uniform system by which one can control components deployed on disparate platforms, operating systems, and developed in different languages.

Accordingly, there exists a need for a system and method for controlling, pausing, and activating a component deployed or registered with the software application or hardware system during run time, without requiring human programming or computer code generation. It is desirable that components operating on such invention are located either locally or remotely to the system or application implementing the invention.

It is also desirable that such invention can automatically pause or activate a software component at runtime, by changing the status of the component, without requiring human interaction or malfunctioning. It is further desirable that such invention allow for interaction with a wide variety of components, and can be developed or programmed in a wide variety of languages, platforms and operating systems, enabling the system to manage the state of components registered with it, regardless of the programming language or operating system of the component.

### SUMMARY OF THE INVENTION

A Component State Modifier (“CSM”) at run-time, can pause or activate a component that is deployed or registered with the software application or hardware system that implements the system without requiring the user to program specific computer code. The components can be either local or remote to the application or system that the application resides.

The system includes a first computing environment including a server configured to select and manipulate a static agent to control the component, a server registry including static agent reference information and a static agent responsive to the server. The system includes a second computing environment including a static agent configured to generate a dynamic agent and a reference repository to enable manipulation of the server registry. The dynamic agent is responsive to the static agent and is configured to manipulate the application registry. The software component is responsive to the server via the static agent and a dynamic agent. The registry reference repository stores details pertaining to the component and application registry. The application registry contains the keys to the component deployed in the system.

The dynamic agent accesses and manipulates the application registry using reference information and uses the key of the component to manipulate access the component. The dynamic agent alters the status field of the component into either an activated or de-activated mode.

In one embodiment, the first computing environment comprises a first computer, the second computing environment comprises a second computer and the first and second computing environments are in electronic communication with each other.

In another embodiment the first computing environment includes a first operating system and the second computing environment includes a second operating system, and the first operating system is different from the second operating system.

### BRIEF DESCRIPTION OF THE DRAWINGS

The various objects and advantages of the present invention will become apparent to those of ordinary skill in the relevant art after reviewing the following detailed description and accompanying drawings, wherein:

FIG. 1 is a block diagram of a computer system including an example of a component system modifier for controlling components in the system;

FIG. 2 is a flow diagram of the functions of the system including a component system modifier;

FIG. 3 is a flow diagram illustrating assignment and distribution of tasks by the server to the static agents within the system;

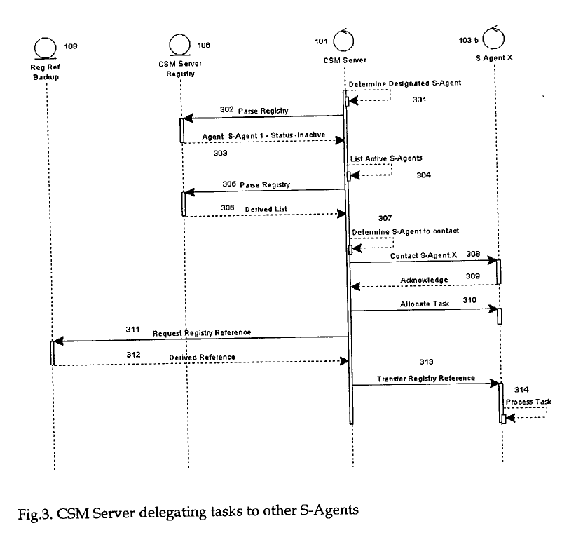

FIG. 4 is a flow diagram illustrating the activation and de-activation of active references after the dynamic agent has completed its task.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated. It should be further understood that the title of this section of this specification, namely, “Detailed Description Of The Invention”, relates to a requirement of the United States Patent Office, and does not imply, nor should be inferred to limit the subject matter disclosed herein.

In the present disclosure, the words “a” or “an” are to be taken to include both the singular and the plural. Conversely, any reference to plural items shall, where appropriate, include the singular.

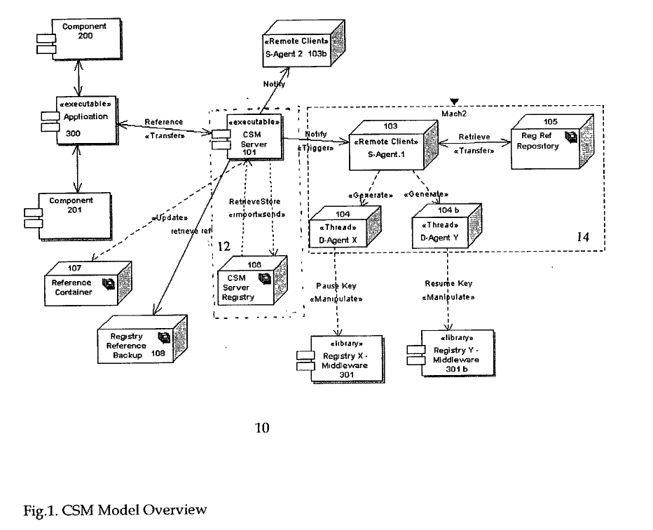

Referring now to the drawings, more particularly FIG. 1, there is shown a System 10 for controlling, activating and de-activating a Software Component 200 registered or deployed in the System 10, at run-time. The System 10 includes a Server 101, one or more Static Agents 103, 103b, one or more Dynamic Agents 104, 104b, a Registry Reference/ Repository 105, a Server Registry 106, a Reference Container 107, a Middleware or Application Registry 301, 302, a Registry Reference Backup 108, one or more Software Components 200, and an Application 300. The term “Agent,” as used herein, is a type of client in a client-server environment. In addition, software components are often referred to as “objects” by those persons skilled in the field of computer programming. The system 10 enables a user or automated program to control software components 200 associated with the application 300 in the system 10 by modifying the registry key of the application 300 and manipulating the reference of the software component 200.

The system 10 can include a first computing environment 12 including the server 101 and the server registry 106 and a second computing environment 14 including a static agent 103, a dynamic agent 104, a registry reference repository 105 for storing details pertaining to the software component 200, and an application registry 301. It is contemplated that the first and second computing environments 12, 14 can be physically located on a single computer. It is also contemplated that the first computing environment can comprise a first computer and the second computing environment 14 can comprise a second computer. As such, the first and second computing environments 12, 14 are in electronic communication with each other such as by a computer network. Notably it is also contemplated that the server 101, static agent 103, server registry 106, registry reference repository 105 and other associated entities can be remotely distributed or located over several computers in a network or the system 10. The first computing environment can include a first operating system and the second computing environment can include a second operating system. It is contemplated that the first operating system can be different or the same as the second operating system.

The server 101 is configured for performing multiple functions, which include, receiving requests or tasks and information, retrieving, transferring and storing information, comparing and matching information, and controlling associated entities, such as the static agent 103, dynamic agent 104, 104b, the server registry 106 and application registry 301, 302. The server 101 is in coupled communication with the application 300, the static agent 103, the dynamic agent 104, the reference repository 105, one or more application registries 301, 302, the registry reference backup 108, the reference container 107, and the component 200.

The component 200 is configured to be controlled using normal programming practices generally known to those skilled in the art. Further, it is contemplated that the System 10 compiles the component 200 using standard compiling tools or compilers generally known to those skilled in the art.

In the present embodiment, the System 10 is configured to use a JAVA based programming language and environment. However, it is also contemplated that other programming languages and environments recognized by those skilled in the art, can be used to control the component 200, without departing from the scope of the present invention. It is also contemplated that the server 101, the server registry 106, and the static agent 103 can be developed using the same or different computer programming languages and operate on different operating systems than the component 200.

To initiate control of the component 200, a control command or task is generated by a user, or automated application, in coupled communication with the system 10. The control command is received by the system 10. The command can be sent directly to the server 101 or through other programs or applications having the architecture to encapsulate the application 300 or the capability to integrate with the application 300, such as the application's user interface (not shown).

The server 101 is in coupled communication with one or more server registries 106. The server registry 106 is configured or programmed to store and maintain reference and identification information pertaining to the static agents 103, 103b, dynamic agents 104, 104b, application registries 301, 302 and other associated entities registered in the system 10. The reference of the static agents 103, dynamic agents 104, application registries 106 and other entities includes proprietary information, enabling communication or manipulation of the entity. This information includes the name of the entity, the location of the entity (IP address of the machine where it resides), the methods that the entity exposes for re-use or manipulation, methods of communication, protocols, and any other information suitable and necessary to enable access to the entity. Preferably, this reference and identification information is registered with the server registry 106 upon activation or creation of the entity.

The server registry 106 stores details or ID information pertaining to static agents 103, 103b registered or deployed with the system 10. The ID information can include the name of static agent 103, the designated machine address of the static agent 103, the protocols used by the static agent 103 for communication with other applications, the operating system of the server registries 106 that the static agent 103 is configured to reside on, the static agent's host name, the date and time of creation of the static agent 103, the task or function assigned to the static agent 103 and the results of the functions or tasks performed by the static agent 103. Additionally, the server registry 106 stores information pertaining to the dynamic agents 104, 104b, and the tasks performed by the dynamic agents 104, 104b.

Upon receiving the instructions to change the status of the component 200, the application 300 transfers the relevant parameters of the reference of the component 200 to the server 101. Possible parameters can be the bind name of the component 200, or the complete name of the component 200. The type or form of the parameter passed on to the server 101 is dependent on the application 300.

The application registry 301 stores and maintains information and the registry key of the components 200 registered and deployed in the system 10. The registry key enables an entity to access and manipulate the designated component 200. The reference repository 105 maintains reference information of designated application registries 301, 302 deployed or registered with the System 10. The application registry reference information enables the server 101 and static agents 103, 103b to manipulate the application registry 301.

The server 101 searches the server registry 106 for an application registry 301 that the designated component 200 is deployed. When an application registry 301 that the component 200 is registered is located in the repository 105, the reference of that registry 301 is extracted from the repository 105.

The server 101 parses the server registry 106 for a static agent 103 to perform the task and selects a static agent 103 to process and perform the task. When there are one or more server registries 106, the server 101 searches the server registries 106 until locating the reference of the selected static agent 103. The server 101 can select the static agent 103 randomly or by matching specific criteria, data or attributes pertaining to the static agent 103, component 200, application registry 301, or application 300. For example, if the designated application registry 301 containing the key to the designated component 200 resides on an IPx/SPx network, then it is preferable to select and transfer the task to an active static agent 103 that is configured to operate on that type of network.

After selecting a static agent 103, the server 101 extracts the reference of the selected static agent 103 from the server registry 106, enabling the server 101 to communicate with the selected static agent 103. The server 101 is the main controller for the static agent 103. The server 101 manipulates the component 200 through the static agent 103. The server 101 transfers the task or function and information to the static agent 103. The server 101 tracks the active/inactive status of the active and inactive of the static agents 103. The registration and tracking enables the server 101 to authenticate the static agents 103. The server 101 and the static agent 103 can exist on different platforms or operating systems or the same platforms and operating systems.

The static agent 103 is in coupled communication with the one or more middleware or application registries 301 deployed in the system 10. The static agent 103 retrieves the reference of the designated application registry 301 from the repository 105. Only static agents 103, 103b registered with the system 10 can control a designated application registry 301. The registry reference repository 105 transfers the reference information of the designated application registry 301 to the static agent 103, enabling the static agent 104 to access and control the application registry 301.

The static agent 103 manipulates the application registry 301, 302 to control, activate or deactivate the selected component 200. To accomplish this, the static agent 103 generates and programs a dynamic agent 104 at run time, to manipulate or access the application registry 301.

The static agent 103 generates a computer code that enables the dynamic agent 104 to access, communicate with the application registry 301 and transfers this code to the dynamic agent 104. The static agent 103 transfers the reference of the application registry 301 to the appropriate dynamic agent 104. The static agent 103 registers the remote reference of the registries 301 with the registry reference repository 105. The static agent 103 assigns the dynamic agent 104, 104b a unique identifier and registers the dynamic agent 104, 104b with the server 101 and the server registry 106.

The unique identifier contains data and information about the attributes of the dynamic agent 104. This data can include the name of the dynamic agent 104, the time and date of creation of the dynamic agent 104, the associated static agents ID, the machine address, the task or function assigned to the dynamic agent 104 and the result of the task performed.

The dynamic agent 104 is registered with the server 101, enabling the server 101 to track of the tasks of the dynamic agent 104, and remain updated of the transactions performed by the dynamic agent 104. Preferably, the static agent 103 generates one dynamic agent 104 for each task or function to be performed. In such a case, if the server 101 calls upon a particular static agent 103 and simultaneously requests the static agent 103 to pause two different components 200, 201, registered with the application registry 301 controlled by the static agent 103, the static agent 103 generates two separate dynamic agents 104, 104b, one for each task.

By creating separate dynamic agents 104, 104b for every task, the static agent 103 can be available to receive new task requests and to perform other tasks, such as reporting to the server 101 on the status of the task. Additionally, by creating a separate dynamic agent 104, 104b for every new and separate request or task, it is unnecessary to spool a request to the static agent 103 or thread the static agent 103, when multiple requests are made on the static agents 103. Once a task or tasks are completed by the dynamic agents 104, 104b the dynamic agent logs or records the performed transaction with the static agent 103 or server 101 and terminates.

As previously stated, the server 101 controls the allocation of tasks to the various registered static agents 103, 103b. To process a transaction, the server 101 decides the static agent 103 to be contacted and transfers the instruction or task details to it. In the event that one of the designated static agents 103 is unable to perform the task, or if the designated static agent 103 is unavailable to be assigned the task, the server 101 searches and selects another static agent 103 to contact to process the task.

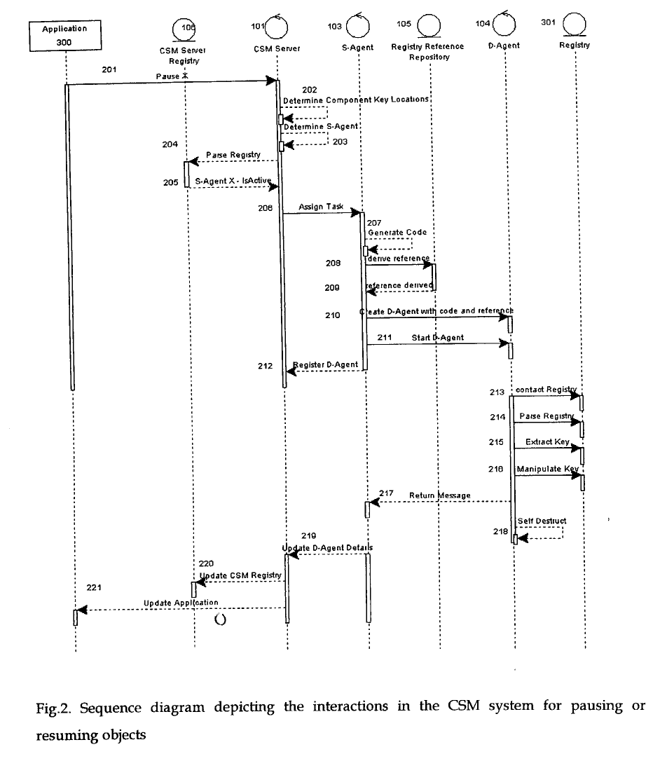

FIG. 2 illustrates the process for controlling, pausing or activating the selected component 200. Upon receiving instructions from a user or automated program to the server 101 searches and obtains information and details of the selected component 201 from the application registry 300. The server 101 obtains information regarding the component 200 such as the component name, the location (IP address of the machine where it resides) the methods that the component exposes for re use and any other type of proprietary information

The server 101 determines the location of the key of the component by looking up the component 200, 201 in the server registry 106, 204. The server 101 parses the server registry 106, 204 to determine which application registry 301 or middleware applications that the component 200 is registered.

Upon determining the appropriate application registry 301 where the component 300 is registered, the server 101 selects a static agent 103 to manipulate the application registries 301, 302. The server 101 ascertains whether the status of the selected static agent 103 is active or inactive, by reading the server registry 106, 204.

If the status of the static agent 103 is active, the server 101 assigns the task to the static agent 103 to pause or activate (depending on the instructions from the user) the component 200, and transfers the details to the static agent 103. The static agent 103 generates the necessary program or code 207 required by the dynamic agent 104 to connect and manipulate the application registry 301. In performing this task, the dynamic agent reports any errors to the static agent 103 and self-destructs on completion of the task.

The registry reference backup 108 stores a copy of the references of the application registry 301 that is initially store in the registry reference repository 105. When a request for activating or deactivating a component sent to the server 101, and the server 101 determines that a particular static agent 103 is inactive 303, the server 101 searches the server registry 301 for a list of the active static agents 103. Upon obtaining a list of active static agents 103, the server 101 selects a static agent 103 to delegate the task to 307. The server 101 then establishes contact 308 with the active static agent 103, contacts the registry reference backup 108 and obtains the reference of the application registry 301 to be manipulated. Because the inactive static agent 103 is unavailable and may hold the references of the application 300 and application registry 301 locally, the static agent 103b, may be unable to contact the application registry 301, because it does possess the reference information necessary to do so.

In such a situation, the server 101 obtains the reference for the application registry 301 from an alternate source, such as the registry reference backup 108. The registry reference backup 108 contains the references for the registered applications 300, application registries 301 and connected components 200. Once the reference to the application registry 301 is obtained. The server 101 transfers the reference to the selected static agent 103, 103b delegated with the task and the static agent 103, 103b proceeds to complete the task.

The static agent 103 generates a dynamic agent 104 and transfers the necessary details including the application registry 301 reference extracted by the dynamic agent 104 to enabling the dynamic agent 104 to communicate with the application registry 301. The static agent 103 registers the dynamic agent 104, 212 with the server 101. The code and reference information enables the dynamic agent 104 to perform the assigned task of pausing or activating the component 200. The static agent 103 then initiates the dynamic agent 104, 211 to complete the task.

Using the extracted reference, the dynamic agent 104 contacts the application registry 301, manipulates and searches the application registry 301, extracts and reads the key 215 of the component 200. The dynamic agent 104 extracts the status field from the key of the component 200 in the application registry 301. If the instructions or task assigned is to pause the component 200, the dynamic agent 104 sets the status field to “Pause” 216, if the status is not already paused and inserts the status back into the key before updating the application registry 301. If the instructions are to activate the component 200, the dynamic agent 104 then sets the status to “Active”, if the status is not already “Active”, and inserts the status back into the key before updating the registry 301.

If the dynamic agent 104 is unable to complete the task, the dynamic agent 104 performs a predetermined number of retries or attempts before submitting a failure notice to the static agent 103. After the static agent 103 informs the server 101 of the successful completion of the task, the server 101 updates the server registry 106. If the task is not completed successfully, the dynamic agent 104 will notify the static agent 103 of the failure and errors in the completion of its task and the dynamic agent 104 proceeds to destroy itself 218. Self-destruction of the dynamic agent 104 frees up storage memory in the System 10.

The static agent 103 informs the server 101 of the status of the task. The server 101 updates the server registry 106, 220 with the details of the task performed by the static agent 103 and dynamic agent 104. The server 101 then updates the application 300 of the status of the task 221.

The reference container 107 stores the references of the component 200 after the dynamic agent manipulated the application registry 301 to pause or activate the software component. After insertion of the altered status field into the key of the component, the server 101 contacts the application 300 to obtain the reference 402 of the paused component 200. Upon receiving the reference 403 of the paused component 200 from the application 300, the server 101 generates a thread 404. The reference of the paused component 200 is inserted into the thread and inserted in the reference container 107.

The server 101 changes the thread's current state into a state of ‘wait’ 406 thereby placing the software component 200 in to a “pause” mode. The server 101 inserts the thread 407 into the reference container 107. It is essential to remove the thread from the application 300 and deposit it in the reference container 107 to enable the system to operate properly. If the active reference, to the software component 200 is still present within the application 300, after the software component 200 has been paused by the server 101, the application 300 will continue to is provide the active reference of the software component 200 to any additional requesting components 201. In this case, the component 201 requesting the reference will not be able to perform since the server 101 has already paused component 200. This situation could potentially result in the malfunctioning of the application 300 and the server 101.

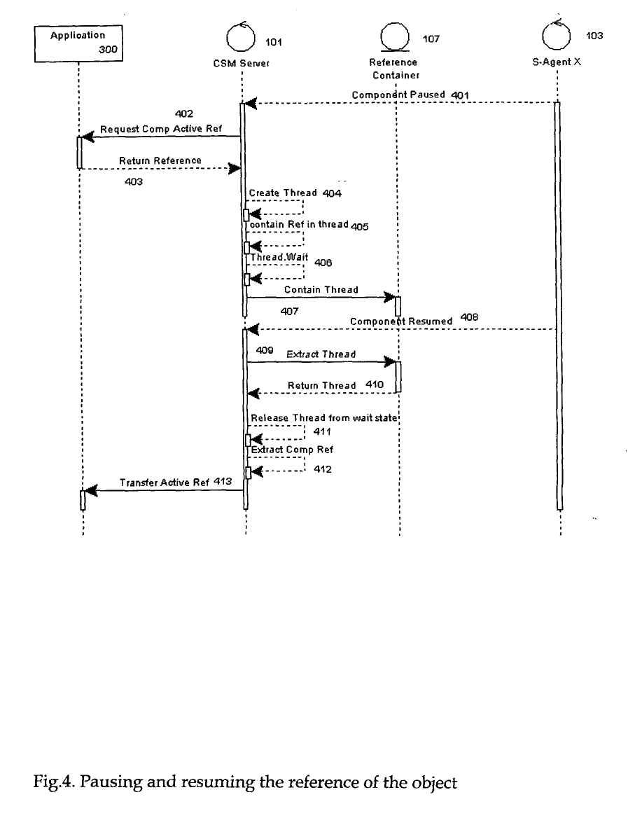

As illustrated in FIG. 4, once the application 300 transfers the reference of the paused component 200 to the server 101, the application 300 will no longer be able to transfer or generate an active reference of the paused component 200 to any other component 201 requesting the reference of the component 200. This effectively completes the process of pausing the component 200.

To activate a paused or de-activated component, the server 101 reads the reference container 107, and extracts the thread 409 containing the reference of the component 200 from the reference container 107. After extracting the thread 410, the server 101 releases the thread from its “wait” state 411, and extracts the component 200 reference. The server 101 transfers the active reference of the component 200 to the application 300. The reference of the component 200 is extracted from the thread by the application 300. On receiving the reference of the component from the server 101 the application 300 is able to process requests from other components requesting the reference for the just resumed component. The software component 200, the server 101 is notified by the static agent 103 of a successful re-activation 408 of the component 200, thereby activating the component 200.

The server 101 and the static agent 103 log or record their respective transactions with the server 101 and other associated registries. After the static agent 103 informs the server 101 of the successful completion of its task, the server 101 updates the server registry 106.

In another embodiment, the system 10 contains a configuration utility, which displays the details of the static agents 103 and the list of registries available on the network. Using the configuration utility, the user can associate a static agent 103 with the registries 301. The configuration utility prepares an object, which contains the details in the form of a unique key for the static agent 103 and its associated registries 106. The tool then updates the server 101 with the unique key generated by it. The configuration tool then derives a reference of the static agent 103 and hands over the same to the server 101. The configuration utility then transfers the copy of the reference to the reference repository backup 108.

What is claimed is:

1. A system for controlling software components, comprising:
a) a first computing environment, the first computing environment configured to include:
1) a server configured to select and manipulate a static agent to control the software component,
2) a server registry including static agent reference information, the server registry associated with the server,
b) a second computing environment, the second computing environment configured to include:
1) a software component;
2) a static agent responsive to the server and configured to generate a plurality of dynamic agents;
3) a registry reference repository including details pertaining to a application registry and the software component, the registry reference repository associated with the static agent;
wherein the software component is controlled by the server of the first computing environment by way of the static agent and the dynamic agent of the second computing environment.

2. The system of claim 1, wherein the first computing environment and the second computing environment are physically located on a single computer.

3. The system of claim 1, wherein the first computing environment comprises a first computer, the second computing environment comprises a second computer and the first and second computing environments are in electronic communication with each other.

4. The system of claim 1, wherein the first computing environment includes a first operating system and the second computing environment includes a second operating system, and the first operating system is different from the second operating system.

5. The system of claim 1, wherein the software component is remote from the server.

6. The system of claim 1, wherein the software component is coupled to an application.

7. The system of claim 1, the second computing environment is further configured to include an application registry containing keys of one or more software components in the system.

8. The system of claim 1, wherein the static agent is configured to generate a computer code to manipulate the application registry.

9. The system of claim 1, wherein the second computing environment includes a plurality of software components and the static agent is configured to generate a plurality of dynamic agents.

10. The system of claim 1, further comprising a dynamic agent responsive to the static agent and configured to manipulate the application registry.

11. The system of claim 1 wherein the dynamic agent extracts the key of the software component from the application registry retrieves the status field of the software component and alters the status field of the software component.

12. The system of claim 1, wherein the server is configured to parse the server registry to determine in which application registry the software component is registered.

13. The system of claim 1, further comprising a reference container wherein the reference container stores software component references information.

14. The system of claim 1, wherein the server is configured to extract the reference of the selected static agent from the server registry to establish communication with the static agent.

15. The system of claim 1, further comprising a registry reference backup for storing references of the software component.

16. A system for controlling software components, comprising:
1) a server registry including static agent reference information;
2) a server configured to access the server registry and to select and manipulate a static agent to control a software component;
3) a registry reference repository stores details pertaining to the software component, the repository in coupled communication with the static agent;
4) a static agent responsive to the server and configured to access the reference repository and to generate a plurality of dynamic agents, each dynamic agent configured to access the reference repository and configured to control a software component; and
5) a plurality of software components responsive to the server by way of the static agent and at least corresponding dynamic agent generated by the static agent.

17. The system of claim 16, wherein the software component is coupled to an application implementing the system.

18. The system of claim 16, further comprising an application registry containing keys of one or more application registries or software components in the system.

19. The system of claim 16, wherein the static agent is configured to generate a computer code to manipulate the application registry.

20. The system of claim 16, further comprising a dynamic agent responsive to the static agent and configured to manipulate the application registry.

21. The system of claim 16, further comprising a reference container in coupled communication with the server, wherein the reference container stores the reference of the software component.

22. The system of claim 16, further comprising a registry reference backup for storing references of the component.

23. A method for controlling software components, the method comprising the steps of:
a) configuring a computing environment to include:
1) a server;
2) a server registry associated with the server and, the server registry
including details of a static agent;
3) a static agent, responsive to the server and configured for generating at least one dynamic agent;
4) an application registry containing component reference information;
5) at least one software component, responsive to the static agent;
6) an application; and
7) a reference container;
b) searching the server registry to locate a static agent;
c) selecting a static agent;
d) generating a code to control the application registry;
e) generating a dynamic agent;
f) transferring the code to the dynamic agent; and
g) manipulating the software component with a server via the static agent and the dynamic agent.

24. The method of claim 23 wherein the static agent details includes reference information enabling the server to access the static agent.

25. The method of claim 23 wherein the server registry:
a) stores static agent reference information;
b) transfers static agent reference information to the server.

26. The method of claim 23 wherein the server registry:
a) stores application registry reference information;
b) transfers application registry reference information to the server.

27. The method of claim 23 wherein the server registry:
a) stores application dynamic agent details;
b) transfers and receives dynamic agent details.

28. The method of claim 23 wherein the server:
a) receives the control command;
b) reads and stores information of the software component;
c) searches the server registry for static agent reference information;
d) extracts static agent reference from the server registry; and
e) selects a static agent to control the component.

29. The method of claim 28 wherein the server randomly selects a static agent to control the component.

30. The method of claim 28 wherein the server selects a static agent by comparing component details to the static agent details.

31. The method of claim 28 wherein the server:
a) transfers component reference information to the static agent;
b) transfers the control command to the static agent.

32. The method claim 28 wherein the application registry stores the key of the software component and the reference container stores the reference of the software component.

33. The method of claim 28 wherein the static agent:
a) generates a dynamic agent to control the component;
b) registers reference information of the dynamic agent with the server registry;
c) generates computer code and application registry reference to manipulate the application registry; and
d) transfers the control command and application registry reference to the dynamic agent.

34. The method of claim 28 wherein the dynamic agent:
a) manipulates the application registry;
b) extracts the key of the component from the application registry;
c) retrieves the status field of the component;
d) alters the status field of the component; and
e) inserts the altered status field back into the key of the component.

35. The method of claim 28 wherein the static agent:
a) generates a unique identifier for the dynamic agent;
b) transfers the unique identifier to the server;
c) transfers status information of the dynamic agent to the server.

36. The method of claim 35 wherein the dynamic agent alters the status field of the component from active to pause.

37. The method of claim 35 wherein the dynamic agent alters the status field of the component from pause to active.

38. The method of claim 23 wherein the server:
a) generates a thread containing the component reference;
b) modifies the thread state; and
c) inserts the thread into the reference container.

39. The method of claim 23 wherein the server:
a) reads the reference container;
b) extracts the thread containing the reference of the component from the reference container;
c) extracts the reference of the component from the thread; and
d) transfers the reference of the component to the application registry.

40. The method of claim 23 wherein the server monitors the status of the dynamic agent.

41. The method of claim 23 wherein the dynamic agent;
a) reports errors in controlling the application registry to the static agent; and
b) terminates after manipulating the application registry.
